(19) United States
(12) Patent Application Publication
(10) Pub. No.: US 2025/0117830 A1
(43) Pub. Date: Apr. 10, 2025

(54) SYSTEM AND METHOD FOR AI BANNER GENERATION COMBINING DESIGN INTELLIGENCE AND DATA INTELLIGENCE

(71) Applicant: Hong Kong Applied Science and Technology Research Institute Company Limited, Hong Kong (HK)

(72) Inventors: Tao YU, Hong Kong (HK); Qijun ZHU, Hong Kong (HK); Huili LI, Hong Kong (HK); Shuyi TANG, Hong Kong (HK); Tsz Chun HO, Hong Kong (HK)

(73) Assignee: Hong Kong Applied Science and Technology Research Institute Company Limited, Hong Kong (HK)

(21) Appl. No.: 18/481,851

(22) Filed: Oct. 5, 2023

(51) Int. Cl. G06Q 30/0241; G06Q 30/0242

(52) U.S. Cl. CPC G06Q 30/0276; G06Q 30/0243

(57) ABSTRACT

An AI-based system for the generation, evaluation, and prediction of performance of banner ads for presentation to specific customers or types of customers. A data set of existing banner ads, ad materials, and design and marketing parameters is used to generate a graph-based model. The graph-based model is used to generate original banner ads, which are then evaluated by a machine learning model, which assigns them scores. The highest-scoring banner ads are then presented to customers. The invention can also use a genetic algorithm in combination with iterative evaluation and generation to diversify design and choose the highest ranked banner ads.

### BACKGROUND OF THE INVENTION

The invention relates to the creation and delivery of advertising to customers. Personalization of advertising is and has been a major focus in the advertising and marketing industry, with the goal of delivering the right message to the right customer at the right time. Personalization of marketing materials can be used at various points in the advertising and marketing process, from initial contact to ongoing delivery of marketing content.

One of the main forms of online advertising is the use of banner ads. Current ad banners, and the methods used to generate them, are passive and inefficient: even if the goods and services being advertised are known to be of interest to the customer in other ways, non-personalized content is delivered. For example, every customer views the same banner, or one of a limited set of banners. These banner ads are mostly generated by human beings and methods such as A/B testing, which are limited and time-consuming, are used to select the banner ad(s) to be used in targeted advertising. A system and method for the generation of not only targeted but personalized banner ads based upon parameters designed to appeal to a particular customer would be a useful invention. A system and method for the review and selection of individual banner ads from a collection of potential banner ads and/or elements of banner ads would also be a useful invention.

### SUMMARY OF THE INVENTION

The invention provides an AI solution framework for personalized banner ads. The invention leverages MMKG, AI generation, and AI recommendation to generate personalized banner ads combining both design intelligence and data intelligence. The invention uses an ad banner analysis engine to review datasets of banner ads and their components (e.g. colored backgrounds, text, colors, key visual elements, text placement, inclusion and placement of illustrations) and produce a graph-type dataset for use by a banner ad generation engine, which generates multiple banner ads for presentation to a customer using a genetic algorithm.

The invention then further evaluates multiple banner ads, based on analysis of their individual components, and selects banner ads which are adjudged likeliest to appeal to a particular customer (or particular type of customer) by assigning them one or more numeric scores and presents the highest-scoring banner ads for human review.

The invention also allows users with little or no design expertise, experience, or generation capabilities to generate useful, targeted banner ads for multiple or targeted demographics simultaneously. Further, it allows users to avoid extensive time and money expenditure by way of A/B testing.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an illustration of a typical banner ad and its components.

FIG. 2 is an abstracted flow diagram of the overall method of the invention.

FIG. 3 is an abstracted flow diagram of the AI Banner Ad Analysis Engine process.

FIG. 4 is a partial abstracted flow diagram of the AI MMKG Construction Engine process.

FIG. 5 is a second partial abstracted flow diagram of the AI MMKG Construction Engine process.

FIG. 6 is a flow chart of the genetic algorithm process of the AI Banner Ad creation process.

FIG. 7 is an abstracted flow diagram of the AI Banner Ad Creation Engine process and the AI Banner Ranking Engine process.

FIG. 8 is an abstracted flow diagram of the ID embedding generation process portion of the AI Banner Ad ranking process.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

For purposes of this application, a “customer” is a person or representative of an entity (e.g. a purchasing manager for a corporation) who is a potential purchaser of a specific good or service to be provided by an advertiser. Further, a “targeted” ad is one which is presented to a customer who is known to be (potentially) interested in a particular good or service. E.g. ads for preschools may be targeted to persons known to be of an age group which is likely to have preschool children. A “personalized” ad is one which is presented to a customer and has one or more attributes related not only to the good or service the customer is known to be interested in, but to one or more things known about that specific customer. E.g. ads for preschools may be personalized for persons known to have preschool-aged children who are searching for information about preschools.

For purposes of describing the invention it will be assumed that the purpose of the banner ad described is to sell a particular physical good, but the invention will work for the marketing of goods and services, as well as for sales, leasing, rental, licensing, or any other commercial exchange between the customer and the advertiser. The “advertiser” is the person or entity ultimately responsible for producing and providing the goods or services, though there may be any number of middle-entities such as ad agencies, ad servers, social media platforms, etcetera. Any of these entities may be the actual practitioner of the invention, though they are all acting for/on behalf of the advertiser so the word “advertiser” should be understood to include such entities when appropriate.

For purposes of this application an “engine” is an AI-based learning model and the processes it uses to collect data, evaluate data, and construct relationships between that data, as well as any output that the model produces after collecting, evaluating, and relating that data. Engines may comprise two or more corresponding parts with individual functions. For purposes of this application “analysis” is the application of an appropriate algorithm or group of algorithms to a data set, either by applying unique algorithms and sequences as set forth herein, or by using algorithms known to the art as identified in the relevant descriptions of each step of the method.

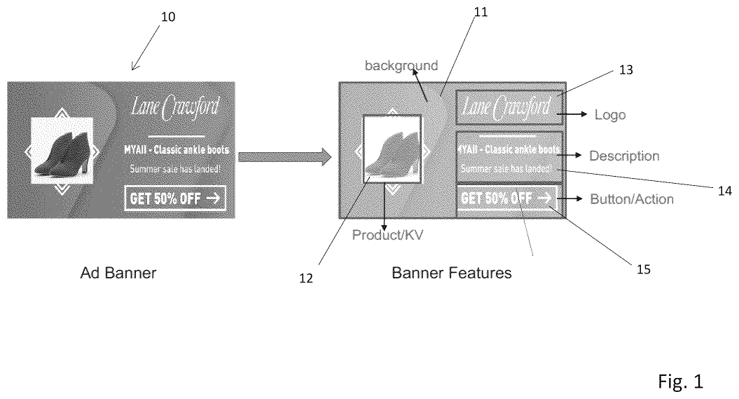

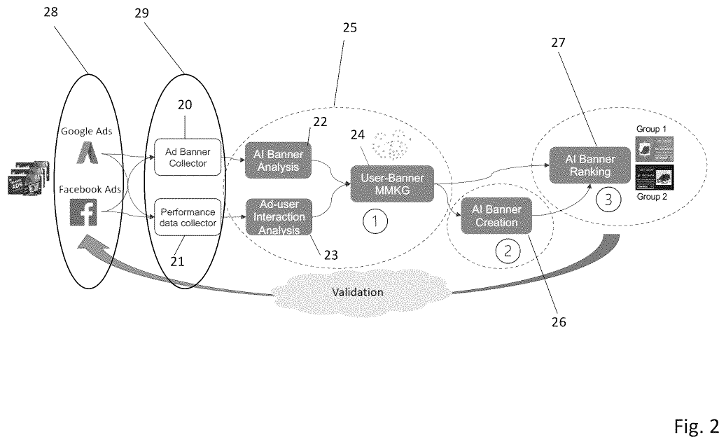

By referring to FIGS. 1 and 2, the basic system and method of the invention may be clearly understood. (Individual elements of the system and method will be described in detail in relation to later illustrations.) Banner ad 10 comprises background 11, key visual (e.g. a photograph or drawing) 12, logo 13, description 14, and button 15. Any given banner ad can contain some or all of these elements. The process of using banner ads to market to customers, which is well known in the art generally, comprises the combining of two or more of these elements to form a banner ad, presenting the banner ad to customers, and then having the customer click on or otherwise respond to the banner ad if they are interested in obtaining the good or service. Techniques such as computer vision (image analysis) are used for the graphic elements of the banner ads as appropriate. Information about an element, such as the position, size, or color of text or key visual elements, can itself be an element.

The overall method of the invention shown in FIG. 2 includes both collecting a group of banner ads to be analyzed by banner ad collector engine 20, and performance data associated with those banner ads by performance data collector engine 21, the two engines comprising AI data acquisition engine 29. The banner ads are collected from banner ad group 28 and related performance data associated with banner ad group 28.

Once the information is collected by the collector engines, the ad banners are subjected to analysis by an AI banner ad analysis engine 22, including the identification and breakdown of individual banner ad elements as shown in FIG. 1, and the related performance data is analyzed by an Ad-user analysis engine 23. These analyses are combined by AI MMKG construction engine 25 to form a multi-modal knowledge graph or MMKG 24, which provides information related to the performance not only of individual banner ads, but of individual ad banner elements in relation to a particular kind of user, good, or service. AI banner ad analysis engine 22 also parses any text associated with the banner ads.

The MMKG feeds output data to AI banner ad creation engine 26, which generates multiple banner ads by combining elements from the banner ad elements of the banner ads as provided by AI banner ad analysis engine 22 and/or user input and organized in the MMKG and using a genetic algorithm to produce the multiple banner ads. The number of ads generated can be set to any reasonable number, but in most applications there will be thousands or tens of thousands of generated ads. Generating a large number of candidates for evaluation and eventual scoring reduces the likelihood that the cycle will have to be repeated.

The generated banner ads are then evaluated by the AI banner ad ranking engine 27 by use of content and performance-based scoring. (see below.) Each banner ad is assigned one or more scores and then ranked according to a ranking algorithm. The banner ad or ads with the highest scores may then be presented to customers for marketing purposes. If none or an insufficient number of the banner ads achieve a minimum acceptable score, as set in the algorithms of the AI banner ad ranking system, they can be processed with the genetic algorithm to provide additional variations and the additional variations then re-ranked, et cetera, until the minimum number of banner ads with minimally acceptable scores are generated. It is preferred, but not required, to generate a sufficient number of banner ads in the first application of the genetic algorithm to avoid having to run the genetic algorithm more than once, as it consumes excess time and space to avoid duplicate banner ads if the genetic algorithm is run multiple times. This also minimizes compute time and related inefficiencies. It is not required that the method of the invention include multiple applications of the genetic algorithm.

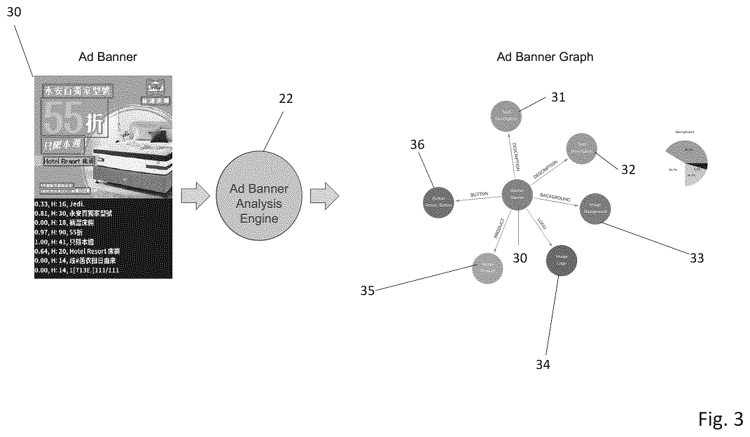

FIG. 3 shows the elements of the AI banner ad analysis engine. Banner ad 30 is fed into AI banner ad analysis engine 22. The engine then categorizes the banner ad in association with its component elements, including but not limited to first text element 31, second text element 32, background element 33, logo element 34, image element 35, and button/action element 36. A knowledge graph is then constructed using the elements of the banner ad(s) and the banner ads themselves fed into AI banner ad analysis engine 22 as vertices.

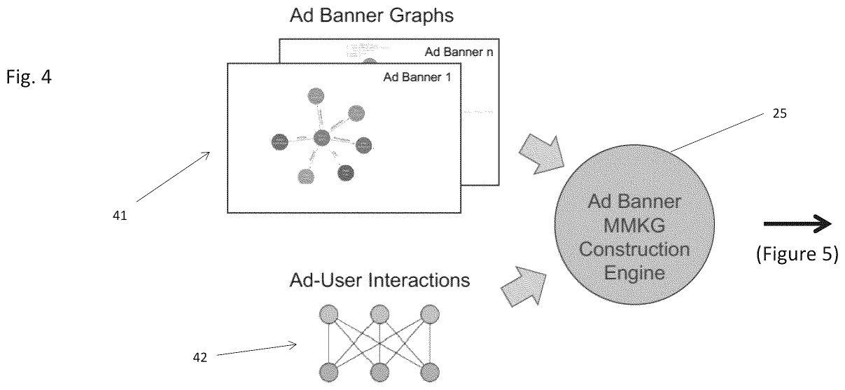

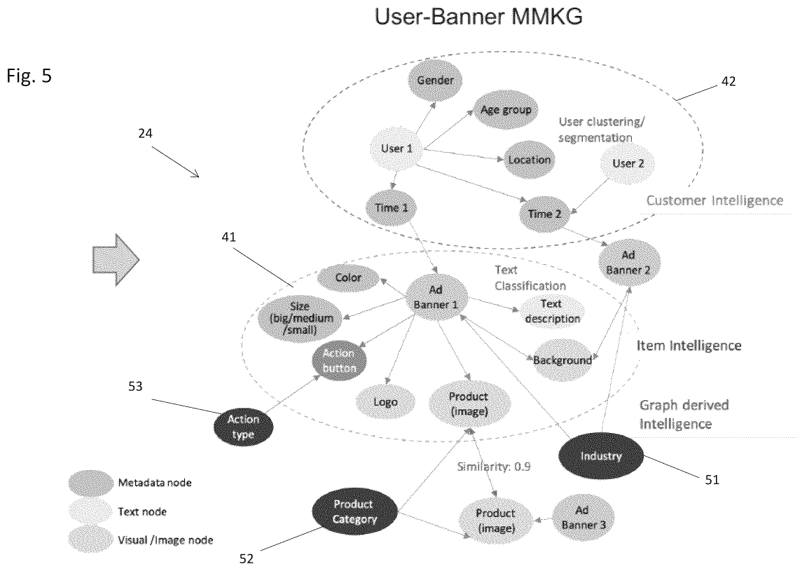

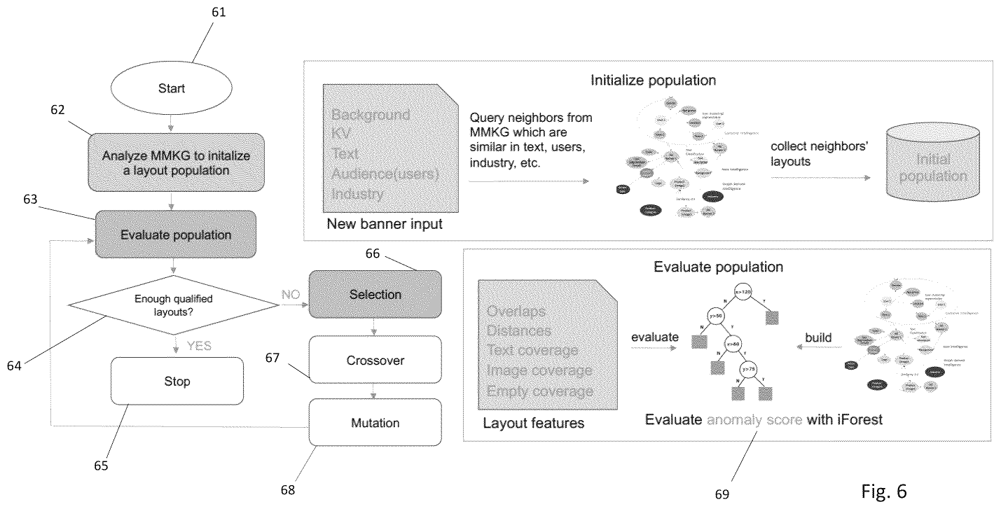

FIGS. 4 and 5 show the combination of the banner ad graphs 41 as described in FIG. 3 with ad-customer interaction graphs 42. These graphs are then fed into AI MMKG construction engine 25 to generate MMKG 24, which comprises the combination and correlation of banner ad graph(s) 41 with ad-customer interaction graph(s) 42. From these combinations, relations including “has,” “owns,” or “is,” et cetera, between the nodes of banner ad graphs 41 for different individual products can be determined in relation to intelligence nodes such as industry node 51 and product category node 52 set in the MMKG 24 by direct entry and/or by data harvesting from the banner ad graph(s) 41 and ad-customer interaction graph(s) 42. The similarity data is then used in the AI banner ad creation engine 26 and the AI banner ad ranking engine 27 (see FIG. 6.)

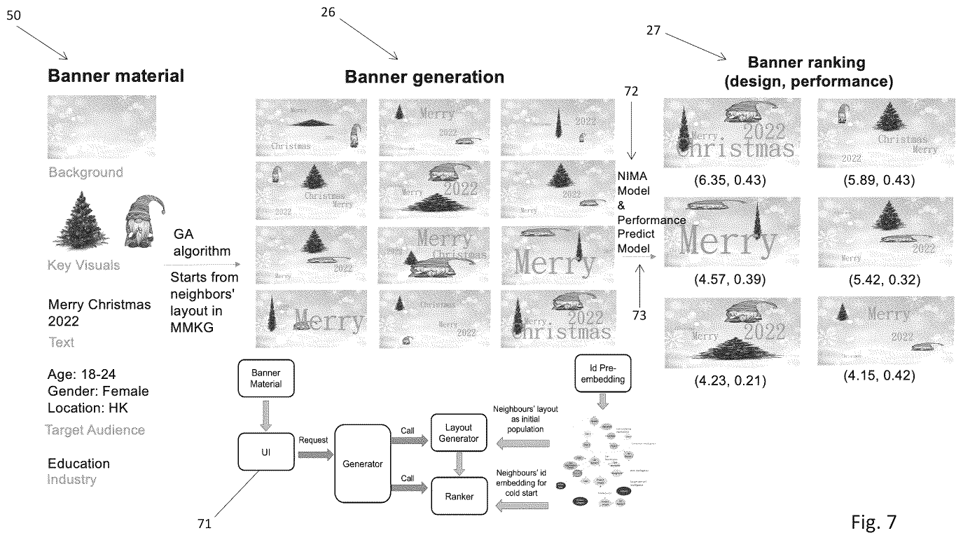

FIGS. 6 and 7 shows the use of MMKG 24 in banner ad creation engine 26. Appropriate banner ad elements stored in MMKG 24 or obtained from online input are combined according to a generation algorithm with initial parameters set by a user with user interface 71. A genetic algorithm is generally used for this purpose.

The process begins as set forth above with start step 61, AI banner ad creation step 62, and AI banner ad evaluation step 63.

For purposes of this application the terms “evaluation” and “ranking” are used. “Evaluation” means evaluating a generated banner ad according to a relatively simple algorithm for significant anomaly or divergence from the desired results (see anomaly evaluation process 69, below.) It is performed on large sets of generated banner ads and should be designed to use a minimum of steps and computing power. “Ranking” means evaluating a set of generated banner ads according to a deep learning model for final selection of a subset of generated banner ads for human evaluation and selection. It is performed on relatively smaller sets of generated banner ads and should be designed to use adequate steps to provide the human user with the most preferred subset of generated banner ads for review.

If enough banner ads are generated according to qualified count step 64, the process stops in stop step 65. Otherwise, the banner ads which are closest to qualified are selected in selection step 66, and then are processed with a genetic algorithm (e.g. DEAP, see: Félix-Antoine Fortin, François-Michel De Rainville, Marc-AndréGardner Gardner, Marc Parizeau, and Christian Gagné. 2012. “DEAP: Evolutionary Algorithms Made Easy.” J. Mach. Learn. Res. 13, 1 (January 2012), 2171-2175) in crossover and mutation steps 67 and 68. The group of processed ads are then re-evaluated in AI banner ad evaluation step 63. This process continues until the system determines that one or more banner ads has met or exceeded the required combination ranking. It is optional to also allow the process to be stopped after a set number of cycles, a set amount of time, and/or until the system determines that the combination rankings are not increasing and/or are not likely to increase further given current parameters. The user is then advised of which outcome(s) occurred.

Anomaly evaluation process 69 is part of AI banner ad evaluation step 63 and uses an anomaly scoring algorithm such as the Isolation Forest (or ‘iForest’) algorithm, which is known in the art. (See: F. T. Liu, K. M. Ting and Z. -H. Zhou, “Isolation Forest,” 2008 Eighth IEEE International Conference on Data Mining, Pisa, Italy, 2008, pp. 413-422, doi: 10.1109/ICDM.2008.17.) This allows the system to discard anomalous banner ads which are too divergent from the other members of the set of banner ads in MMKG 24 to be used in the process described below and/or as parents in the next generation of banner ads.

The group of generated banner ads is then evaluated for design quality with an appropriate design quality algorithm 72, e.g. the Neural IMage Assessment algorithm or NIMA, which is known to the art (see: H. Talebi and P. Milanfar, “NIMA: Neural Image Assessment,” in IEEE Transactions on Image Processing, vol. 27, no. 8, pp. 3998-4011 August 2018, doi: 10.1109/TIP.2018.2831899.) The group of banner ads is also evaluated for performance quality with an appropriate performance quality algorithm 73, also known to the art. Each generated banner ad is assigned a combination ranking based on design quality and performance quality, the creation and combination of these scores being the purpose of AI banner ad ranking engine 27. The highest ranked banner ads can then be presented to customers, either directly or through manual review by advertisers or other human users. If an insufficient number of acceptable ads is presented, the user can attempt to reset the initial parameters, or add additional steps such as shown in FIG. 6.

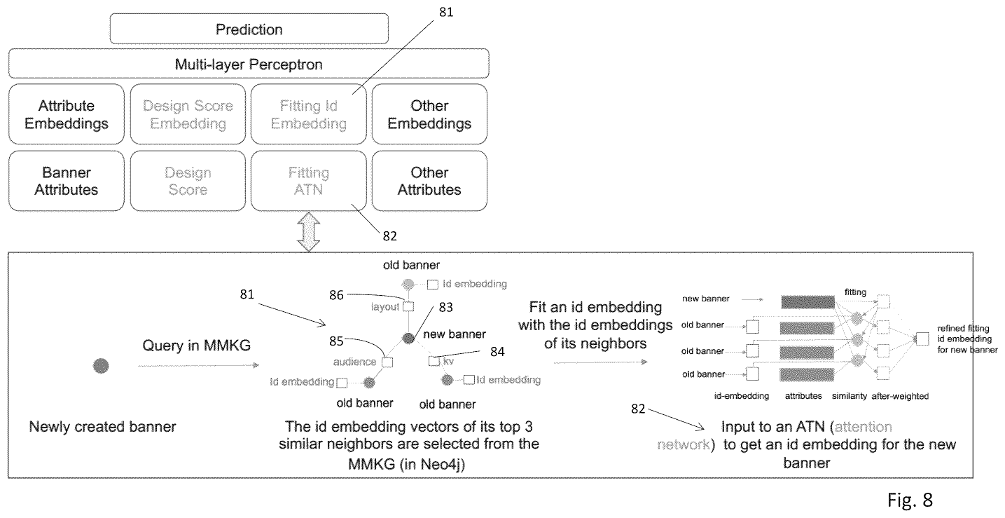

FIG. 8 shows an additional feature of the invention which allows a “rigid cold start” to the banner ad generation process. Banner ads present in the MMKG have an associated id embedding representing one or more elements of the banner ad's properties. A banner ad newly created by the AI banner ad creation engine has never been seen by a user or shown in a sample set, and thus there is no id embedding for it in the MMKG. This will reduce the usefulness of the AI banner ad evaluation step 63 if applied to such banner ads.

A fitting ID embedding fitting model 81 is used to fit an id embedding vector for a newly created banner ad 83 from the three (or any arbitrary number) closest neighbors. These neighbors are selected according to one or more correlation factors, such as closest KV element 84, closest audience element 85, and closest layout element 86. The combination of these id embeddings come from attention network 82, which generates a weighted combination id fitting for newly created banner ad 83. This is applied to the newly created banner ad 83, and the newly created banner ad 83 can then be subjected to the Al banner ad ranking engine.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A system for AI banner generation comprising:
a group of banner ads comprising one or more banner ads, each of the banner ads having one or more banner ad elements;
a group of banner ad performance records comprising one or more banner ad performance records, each of the banner ad performance records corresponding to at least one of the one or more banner ads;
a data acquisition engine which collects the group of banner ads and stores the group of banner ads in a first electronic file and collects the group of banner ad performance records and stores the banner ad performance records in a second electronic file;
a multi-modal knowledge graph (MMKG) engine which analyzes the first electronic file and the second electronic file to produce an MMKG, the MMKG comprising a graph model of the correlated banner ad elements and corresponding banner ad performance records, and stores the MMKG in a third electronic file;
a banner ad creation engine which analyzes the MMKG and produces a group of AI generated banner ads using a genetic algorithm, comprising one or more AI generated banner ads comprised of conglomerations of the banner ad elements, and stores the AI generated banner ads in a fourth electronic file; and
a banner ad ranking engine which analyzes the group of AI generated banner ads and assigns each of the AI generated banner ads a design score and a performance score and then ranks the AI generated banner ads based on a weighted ranking of the performance score and the design score of each of the AI generated banner ads.

2. The system for AI banner generation of claim 1 wherein the first electronic file and the second electronic file are the same electronic file.

3. The system for AI banner ad generation of claim 1 wherein the banner ad ranking engine determines if a minimum number of AI generated banner ads meets and/or exceeds a minimum weighted ranking and if not, selects a subgroup of the AI generated banner ads, alters the AI generated banner ads in the subgroup with the genetic algorithm to produce a group of altered AI generated banner ads, and uses the subgroup in generating a second generation of AI generated banner ads.

4. The system for AI banner ad generation of claim 1 wherein the banner ad creation engine determines if one or more of the AI generated banner ads is more anomalous from the group of banner ads in the MMKG than a predetermined anomalousness threshold and if so not offer such anomalous AI generated banner ads for presentation to customers.

5. The system for AI banner ad generation of claim 3 wherein the banner ad creation engine determines if one or more of the altered AI generated banner ads is more anomalous from the group of banner ads in the MMKG than a predetermined anomalousness threshold and if so not use such anomalous altered AI generated banner ads in generating the next generation of AI generated banner ads.

6. A method for AI banner ad generation comprising the steps of:
collecting a group of banner ads comprising one or more banner ads, each of the banner ads having one or more banner ad elements;
collecting a group of banner ad performance records comprising one or more banner ad performance records, each of the banner ad performance records corresponding to at least one of the one or more banner ads;
analyzing the group of banner ads and the group of banner ad performance records to produce a multi-modal knowledge graph (MMKG) comprising a graph model of the correlated banner ad elements and corresponding banner ad performance records;
analyzing the MMKG to produce a group of AI generated banner ads using a genetic algorithm, comprising one or more AI generated banner ads comprised of conglomerations of the banner ad elements;
storing the AI generated banner ads in an electronic file;
analyzing the group of AI generated banner ads to assign each of the AI generated banner ads a design score and a performance score; and
ranking the AI generated banner ads based on a weighted ranking of the performance score and the design score of each of the AI generated banner ads.

7. The method for AI banner ad generation of claim 6 further comprising the steps of:
determining if a minimum number of AI generated banner ads meets and/or exceeds a minimum weighted ranking, if so stopping the method otherwise proceeding to the next step;
selecting a subgroup of the AI generated banner ads;
altering the AI generated banner ads in the subgroup with the genetic algorithm to produce a group of altered AI generated banner ads; and
generating a second generation of AI generated banner ads using the group of altered AI generated banner ads as an input to the genetic algorithm.

8. The method for AI banner ad generation of claim 6 further comprising the steps of:
determining if one or more of the AI generated banner ads is more anomalous from the group of banner ads in the MMKG than a predetermined anomalousness threshold and if so not offering such anomalous AI generated banner ads for presentation to customers.

9. The method for AI banner ad generation of claim 7 further comprising the steps of:
determining if one or more of the altered AI generated banner ads is more anomalous from the group of banner ads in the MMKG and/or the AI generated banner ads than a predetermined anomalousness threshold and if so not using such anomalous altered AI generated banner ads in generating the second generation of AI generated banner ads.

10. The method for AI banner ad generation of claim 7 further comprising the steps of:
determining if one or more of the AI generated banner ads is more anomalous from the group of banner ads in the MMKG than a predetermined anomalousness threshold and if so not offering such anomalous AI generated banner ads for presentation to customers.

11. The method for AI banner ad generation of claim 7 wherein the group of banner ad performance records covers performance of the banner ads with regard to at least two distinct demographic groups.

12. The system for AI banner ad generation of claim 1 wherein the banner ad creation engine determines if one or more of the AI generated banner ads is more anomalous from the group of banner ads in the MMKG and/or the AI generated banner ads than a predetermined anomalousness threshold and if so not offer such anomalous AI generated banner ads for presentation to customers.

13. The system for AI banner ad generation of claim 3 wherein the banner ad creation engine determines if one or more of the altered AI generated banner ads is more anomalous from the group of banner ads in the MMKG and/or the AI generated banner ads than a predetermined anomalousness threshold and if so not use such anomalous altered AI generated banner ads in generating the next generation of AI generated banner ads.

14. The method for AI banner ad generation of claim 6 further comprising the steps of:
determining if one or more of the AI generated banner ads is more anomalous from the group of banner ads in the MMKG than a predetermined anomalousness threshold and if so not offering such anomalous AI generated banner ads for presentation to customers.
